(19) United States
(12) Patent Application Publication
(10) Pub. No.: US 2013/0277462 A1
(43) Pub. Date: Oct. 24, 2013

(54) AIR FLOW SWITCH FOR AN ELECTROSTATIC TOOL

(71) Applicant: FINISHING BRANDS HOLDINGS INC., Minneapolis, MN (US)

(72) Inventor: James P. Baltz, Waterville, OH (US)

(73) Assignee: Finishing Brands Holdings Inc., Minneapolis, MN (US)

(21) Appl. No.: 13/798,075

(22) Filed: Mar. 12, 2013

Related U.S. Application Data
(60) Provisional application No. 61/635,823, filed on Apr. 19, 2012.

(51) Int. Cl. B05B 5/053; H02K 7/18

(52) U.S. Cl. CPC B05B 5/0532; H02K 7/1823
USPC 239/690; 290/52

(57) ABSTRACT

A power module of electrostatic tool is provided with an air flow switch. The air flow switch receives an air flow through one passage and outputs two portions of that air flow through two other passages when the air flow exceeds a threshold pressure.

### CROSS-REFERENCE TO RELATED APPLICATION

This application claims priority to and benefit of U.S. Provisional Patent Application No. 61/635,823, entitled “AIR FLOW SWITCH FOR AN ELECTROSTATIC TOOL”, filed Apr. 19, 2012, which is herein incorporated by reference in its entirety.

### BACKGROUND

The present disclosure relates generally to electrostatic spray devices, and, more particularly, to a power supply for an electrostatic spray device.

Electrostatic spray applications use electric power as a means to charge a liquid for spraying over a grounded or inversely charged target object. Traditionally, electrostatic spray coating devices (e.g., spray gun) have been powered from electrical power supplies sending either low or high voltage potential over a cable attached to the spray device. The electrical power supply may be cumbersome to locate and operate outside the area of use, thereby impairing the user's efficiency. Alternatively, electrostatic spray devices may be made cordless by disposing turbine generators or batteries on or within the device. Unfortunately, additional spray device weight may make the spray device more difficult and uncomfortable to use, especially during extended use. Further, mobile exterior power supplies are subject to contamination from the paints and solvents used in the coating application and cleanup process.

### BRIEF DESCRIPTION

In an embodiment, a system includes a power module for an electrostatic tool, which has an air flow switch. The air flow switch has three air flow passages. Two of the air flow passages are configured to output a portion of the air flow received at the other air flow passage. Further, the air flow switch is configured to allow air to pass through the air flow passages when the air entering into the switch exceeds a threshold pressure.

In another embodiment, a system includes a power module for an electrostatic spray device. The power module has an air flow switch. The air flow switch has a piston. Further, the air flow switch is configured to receive an air flow and output two air flows when the first air flow exceeds a threshold pressure.

In another embodiment, a system includes a spray coating device configured to output an electrostatically charged spray and a power module. The power module has and air flow switch containing three air flow passages. The first air flow is configured to receive an air flow. The second air flow passage is configured to direct a portion of the first air flow to a turbine generator. The third air flow passage is configured to direct another portion of the first air flow to the spray coating device. Further, the air flow switch is configured to flow air through the air flow passages when the first air flow exceeds a threshold pressure.

These and other features, aspects, and advantages of the present disclosure will become better understood when the following detailed description is read with reference to the accompanying drawings in which like characters represent like parts throughout the drawings.

### BRIEF DESCRIPTION OF THE DRAWINGS

FIG. 1 is a block diagram illustrating an electrostatic spray tool having a spray generator, wherein the electrostatic spray tool is configured to output an electrostatically charged spray;

FIG. 2 is a schematic view of an embodiment of an electrostatic spray tool having a spray generator, gas input, and voltage input;

FIG. 3 is a schematic view of an embodiment of an electrostatic spray tool having a portable power module;

FIG. 4 is a schematic view of an embodiment of the power module of FIG. 3;

FIG. 5 is a circuit diagram illustrating an embodiment of the electrical routing of power and ground lines of the electrostatic spray tool of FIG. 1;

FIG. 6 is a diagram illustrating an embodiment of the electrostatic spray tool of FIG. 1 illustrating an application of the power module of FIG. 3;

FIG. 7 is a cross-sectional view of an embodiment of the air flow switch from FIG. 4 illustrating the air flow switch in a closed position; and

FIG. 8 is a cross-sectional view of an embodiment of the air flow switch from FIG. 4 illustrating the air flow switch in an open position.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

Various embodiments of the present disclosure include an electrostatic tool for providing an electrostatically charged spray to coat a target object. As discussed in detail below, the electrostatic spray tool includes a power module that receives an air flow from an air supply. The power module further includes an air flow switch to divert the air flow to drive a generator. The electrostatic spray tool uses the power produced by the generator to create an electrostatically charged spray and supply a gas output to a spray device for atomizing the electrostatically charged spray. The charge in the electrostatically atomized spray enables the spray to wrap around the target object and cover the target object with the spray. As discussed in detail below, the placement and configuration of the power module may reduce the number of cables used with the electrostatic tool while improving the ergonomics of an electrostatic spray system, thereby protecting the power supplies and improving user efficiency, while using cost effective parts. Various embodiments of the present disclosure provide a power module having an air flow switch that detects a change in air flow so as to reduce the need for extra cables, hoses, and/or additional weight in the spray device. Specifically, by placing an air flow switch in the power module, the power module may be remote from the spray coating device (e.g., spray gun) without extra cables and/or impairing user efficiency. For example, the power module may be removably coupled to the user (e.g., waist/belt mounted) or remotely installed to enable control of electrostatic spray tool while the user is in the area of use.

Removably coupling the power module on the user may have multiple advantages over existing tools. First, the placement makes spray device lighter and more comfortable to use by reducing need of batteries or turbine generators in or on the spray coating device. Second, placing the power module in a portable configuration may reduce spray coating device weight and increase user comfort during use by reducing weight and bulk of cable bundles. Reducing the number of required cables or hoses also reduces strain on the connections of cable bundles and lengthens cable life by reducing abrasion and snagging of the cable bundle within an area of use.

In certain embodiments, the power supply may be operated by releasing pressure downstream from the air flow switch by activating the spray device. The pressure differential across the switch activates the switch and sends a pneumatic flow to drive the power supply. While certain embodiments contemplate removably coupling the power module on the user, some embodiments may mount the power module in other suitable configurations whether portable or in a fixed location.

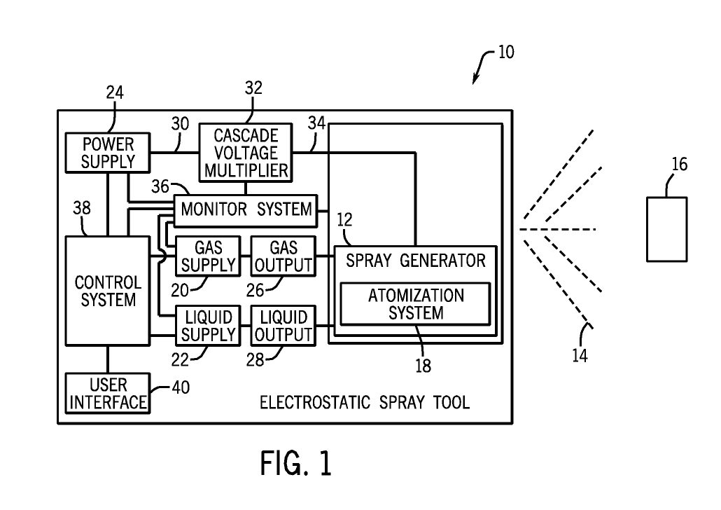

Turning now to the drawings, FIG. 1 is an embodiment of an electrostatic spray tool system 10, which includes a spray generator 12 configured to apply an electrostatically charged spray 14 to at least partially coat an object 16. The electrostatically charged spray 14 may be any substance suitable for electrostatic spraying such as liquid paint or powder coating. Furthermore, the spray generator 12 includes an atomization system 18. As further illustrated in FIG. 1, the electrostatic spray tool 10 includes a gas supply 20 (e.g., air supply), liquid supply 22, and a power supply 24. The power supply 24 may be a turbine generator fed by the gas supply 20, an external electrical supply, a battery, or any other suitable method of supplying power. The gas supply 20 provides a gas output 26 to the spray generator 12. Similarly, the liquid supply 22 provides a liquid output 28 to the spray generator 12. In the illustrated embodiment, the atomization system 18 is a gas atomization system which uses the gas from gas supply 20 to atomize the liquid from the liquid supply 22 to produce a liquid spray. For example, the atomization system 18 may apply gas jets toward a liquid stream, thereby breaking up the liquid stream into a liquid spray. In certain embodiments, the atomization system 18 may include a rotary atomizer, an airless atomizer, chamber of passageways, nozzle, or another suitable atomizer. Additionally, the gas supply 20 may be an internal or external gas supply, which may supply nitrogen, carbon dioxide, air, another suitable gas, or any combination thereof. For example, the gas supply 20 may be a pressurized gas cartridge mounted directly on or within the electrostatic spray tool system 10, or the gas supply 20 may be a separate pressurized gas tank or gas compressor. In various alternative embodiments, the liquid supply 22 may include an internal or external liquid supply. For example, the liquid supply 22 may include a gravity applicator, siphon cup, or a pressurized liquid tank. Further, the liquid supply 22 may be configured to hold or contain water, a powder coating, or any other suitable material for electrostatic spray coating.

As further illustrated in FIG. 1, the electrostatic spray tool system 10 includes a power supply voltage 30, cascade voltage multiplier 32, and multiplied power 34. In certain embodiments, the power supply 24 may supply the power supply voltage 30 as an alternating current. The power supply 24 supplies the power supply voltage 30 to the cascade voltage multiplier 32, which produces some voltage (e.g., multiplied power) suitable for electrostatically charging a fluid. For example, the cascade voltage multiplier 32 may apply the multiplied power 34 with a voltage between approximately 55 kV and 85 kV or greater to the spray generator 12. For example, the multiplied power 34 may be at least 55, 60, 65, 70, 75, 80, 85, 90, 95, 100, or greater kV. As will be appreciated, the cascade voltage multiplier 32 may include diodes and capacitors and also may be removable. In certain embodiments, the cascade voltage multiplier 32 may also include a switching circuit configured to switch the power supply voltage 30 applied to the spray generator 12 between a positive and a negative voltage. Further, spray generator 12 receives the multiplied power 34 to charge the liquid received from liquid supply 22. The current in multiplied power 34 may be low, on the order of approximately 50-100 microamps, so that the charge is essentially a DC static charge. The opposite charge may be created on the object 16 to be coated.

As also illustrated in FIG. 1, the electrostatic spray tool system 10 further includes a monitor system 36 and a control system 38, each of which may be powered by the power supply 24. The monitor system 36 may be coupled to the cascade voltage multiplier 32 and the spray generator 12 to monitor various operating parameters and conditions. For example, the monitor system 36 may be configured to monitor the voltage of the power supply voltage 30. Similarly, the monitor system 36 may be configured to monitor the multiplied power 34 output by the cascade voltage multiplier 32. Furthermore, the monitor system 36 may be configured to monitor the voltage of electrostatically charged spray 14. The control system 38 may also be coupled to the monitor system 36. In certain embodiments, the control system 38 may be configured to allow a user to adjust various settings and operating parameters based on information collected by the monitor system 36. Specifically, the user may adjust settings or parameters with a user interface 40 coupled to the control system 38. For example, the control system 38 may be configured to allow a user to adjust the voltage of the electrostatically charged spray 14 using a knob, dial, button, or menu on the user interface 40. The user interface 40 may further include an ON/OFF switch and a display for providing system feedback, such as voltage or current levels, to the user. In certain embodiments, the user interface 40 may include a touch screen to enable both user input and display of information relating to the electrostatic spray tool system 10, such as the internal pressure of the gas supply 20, liquid supply 22, or within the spray generator 12.

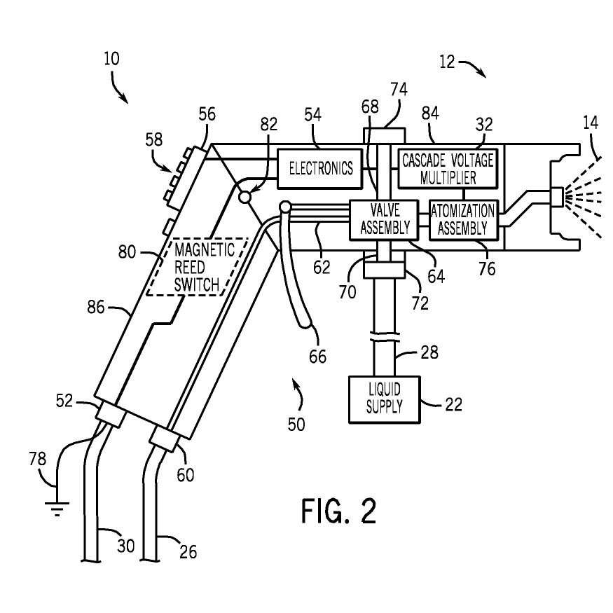

Referring now to FIG. 2, an embodiment of the electrostatic spray tool system 10 is shown, illustrating an electrostatic spray device 50. The electrostatic spray device 50 has the spray generator 12, liquid supply 22, power supply voltage 30, and liquid output 28. The liquid supply 22 in the illustrated embodiment enters into the underside of electrostatic spray device 50, but may be configured to enter electrostatic spray device 50 in any suitable manner, such as by a gravity-fed container, liquid pump coupled to a liquid supply, siphon cup, pressurized liquid tank, pressurized liquid bottle, or any other suitable type of liquid supply system. Furthermore, the liquid supply 22 may be configured to be portable or in a fixed location. Additionally, the electrostatic spray device 50 is configured to create the electrostatically charged spray 14.

As further illustrated in FIG. 2, electrical power is provided to the electrostatic spray device 50 as power supply voltage 30, which enters the electrostatic spray device 50 by an electrical adapter 52. As shown, the electrostatic spray device 50 includes an electronics assembly 54 supplied with electrical power from by power supply voltage 30. The electronics assembly 54 may include the monitor system 36 and/or the control system 38 described above. The electronics assembly 54 may be electrically coupled to a control panel 56. In certain embodiments, the control panel 56 may be included in the user interface 40 described above. For example, the control panel 56 may include buttons, switches, knobs, dials, and/or a display (e.g., a touch screen) 58, which enable a user to adjust various operating parameters of the electrostatic spray device 50 and turn on/off the electrostatic spray device 50.

The cascade voltage multiplier 32 receives electrical power (e.g., power supply voltage 30) from the power supply 24 and supplies the multiplied power 34 to the spray generator 12. In certain embodiments, the multiplied power 34 may be preset to a certain approximate value (e.g., 45, 65, or 85 kV). Accordingly, in certain embodiments, the high voltage power (e.g., multiplied power 34) may be at least approximately 40, 50, 60, 70, 80, 90, or 100 kV. Some embodiments may utilize the control panel 56 to vary the high voltage power between an upper and lower limit. For example, in certain embodiments, the high voltage may be variable between approximately 10 to 200 kv, 10 to 150 kV, 10 to 100 kV, or any sub-ranges therein. Thereafter, the spray generator 12 uses the multiplied power 34 from the cascade voltage multiplier 32 to charge electrostatically charged spray 14.

As further illustrated in FIG. 2, the electrostatic spray device 50 includes the gas output 26 from the gas supply 20 through a pneumatic adapter 60. Specifically, the gas output 26 provides an air flow to spray generator 12 for the atomization of electrostatically charged liquid spray 14. For example, the gas output 26 may supply nitrogen, carbon dioxide, atmospheric air, any other suitable gas, or a combination thereof. As shown, the electrostatic spray device 50 further includes a gas passage 62, which connects the gas output 26 to a valve assembly 64. The valve assembly 64 may be further coupled to a trigger assembly 66. Trigger assembly 66 may be used to initiate a gas flow from the gas output 26 through the valve assembly 64. For example, certain embodiments of the trigger assembly 66 may open a valve in the valve assembly 64 to release pressure in the gas output 26. Further, the valve assembly 64 may be coupled to an upper liquid passage 68 and a lower liquid passage 70. In some embodiments, the upper liquid passage 68 may be configured to couple to a gravity feed supply. As further illustrated in FIG. 2, the lower liquid passage 70 may receive liquid from the liquid supply 22 into the electrostatic spray device 50 via a liquid adapter 72 through the liquid output 28. The electrostatic spray tool system 10 also includes a cap 74, which may be releaseably secured to the electrostatic spray device 50. In some embodiments, the cap 74 may be removed from the electrostatic spray device 50 to instead secure a gravity feed supply covering and sealing the liquid passage 68.

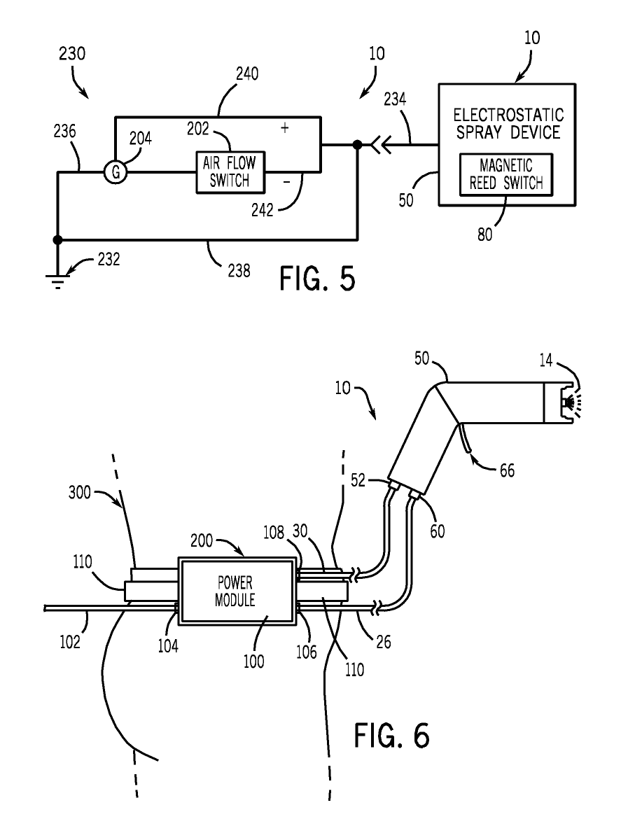

During operation, a user may actuate the trigger assembly 66, which initiates gas flow from the gas output 26 through the valve assembly 64. In addition, the actuation of the trigger assembly 66 initiates a fluid flow from the liquid supply 22 through the valve assembly 64. The gas and fluid flows enter an atomization assembly 76. The atomization assembly 76 uses the gas from the gas output 26 to atomize the liquid supplied by the liquid supply 22. The atomization assembly 76 may include a rotary atomizer, an airless atomizer, chamber of passageways, nozzle, or another suitable method for atomizing liquid for electrostatically charged spray. The spray generated by the atomization assembly 76 passes through the spray generator 12 to generate the charged liquid spray 14. As discussed below in reference to FIG. 5, the electrostatic spray device 50 may further receive an earth ground supply through a connection 78 to comply with any relevant safety regulations. In some embodiments, the connection 78 may be included within a cable bundle that also contains the power supply voltage 30 or delivered separately from the power supply voltage 30. In certain embodiments, the electrostatic spray device 50 may have a magnetic reed switch 80. The magnetic reed switch 80 may be configured such that actuation of the trigger assembly 66 closes the magnetic reed switch 80 contacts and completes an electric circuit containing the power supply voltage 30. As will be appreciated, the inclusion of the magnetic reed switch 80 creates a circuit that may block the creation of the multiplied voltage 34 unless trigger assembly 66 is actuated.

The illustrated embodiment of the electrostatic spray device 50 further includes a pivot assembly 82 between a barrel 84 and a handle 86 of the electrostatic spray device 50. As will be appreciated, the pivot assembly 82 enables rotation of the handle 86 and the barrel 84 relative to one another, such that the user can selectively adjust the configuration of the electrostatic spray device 50 between a straight configuration and an angled configuration. As illustrated, the electrostatic spray device 50 is arranged in an angled configuration, wherein the handle 86 is angled crosswise to the barrel 84. The ability to manipulate the electrostatic spray device 50 in this manner may assist the user in applying the electrostatic spray 14 in various applications. That is, different configurations of the electrostatic spray device 50 may be more convenient or appropriate for applying the discharge in different environments or circumstances.

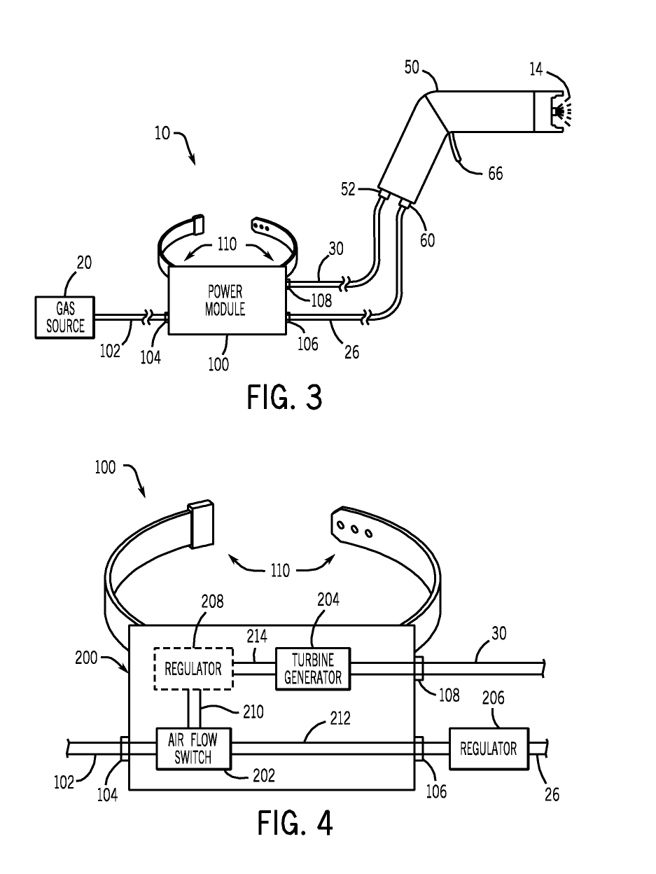

Referring now to FIG. 3, a schematic of an embodiment of the electrostatic spray tool system 10 is shown. The electrostatic spray tool system 10 includes the gas supply 20, a power module 100, and the electrostatic spray device 50. As discussed in greater detail below when referring to FIG. 4, the power module 100 receives a gas intake 102 from the gas supply 20 via a gas adapter 104. Also discussed below, the power module 100 supplies the gas output 26 via a gas adapter 106 and the power supply voltage 30 via an electrical adapter 108. The power module 100 may further include a mounting portion 110 to allow the power module 100 to be mounted. The illustrated embodiment shows the mounting portion 110 as a strap (e.g., a belt), but the mounting portion 110 may also be configured to be at least a portion of a backpack, pouch, or some other suitable method for mounting portably or in a fixed location. As discussed in detail above when referring to FIG. 2, the electrostatic spray device 50 discharges the electrostatically charged spray 14 while receiving the gas output 26 via the gas adapter 52 and the power supply voltage 30 via the electrical adapter 60. As discussed further below in reference to FIG. 4, the illustrated embodiment of the electrostatic spray device 50 also contains the trigger assembly 66 to initiate the flow of air through the gas output 26. As discussed further below, certain embodiments of the electrostatic spray system 10 may include a grounding circuit that has been omitted from FIG. 3 for clarity.

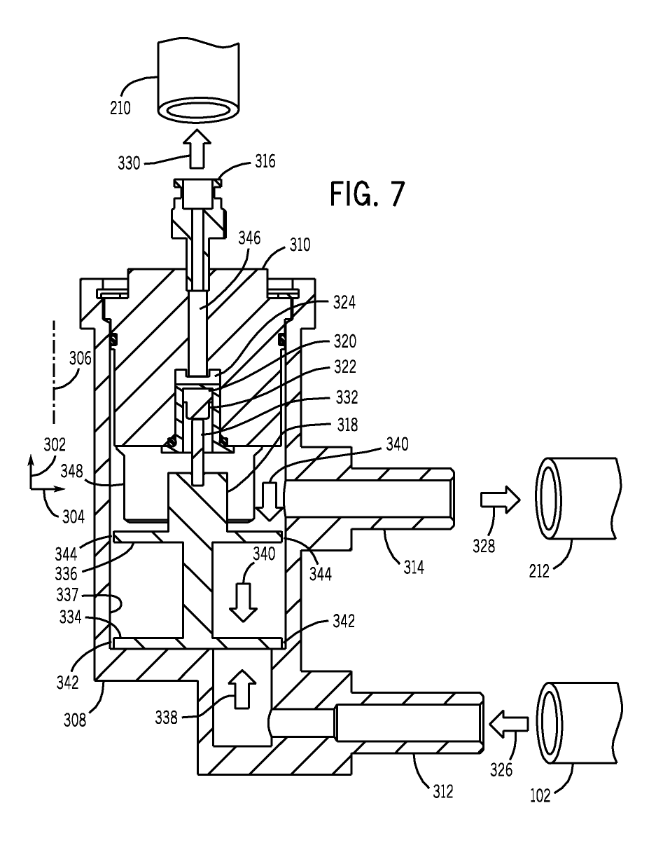

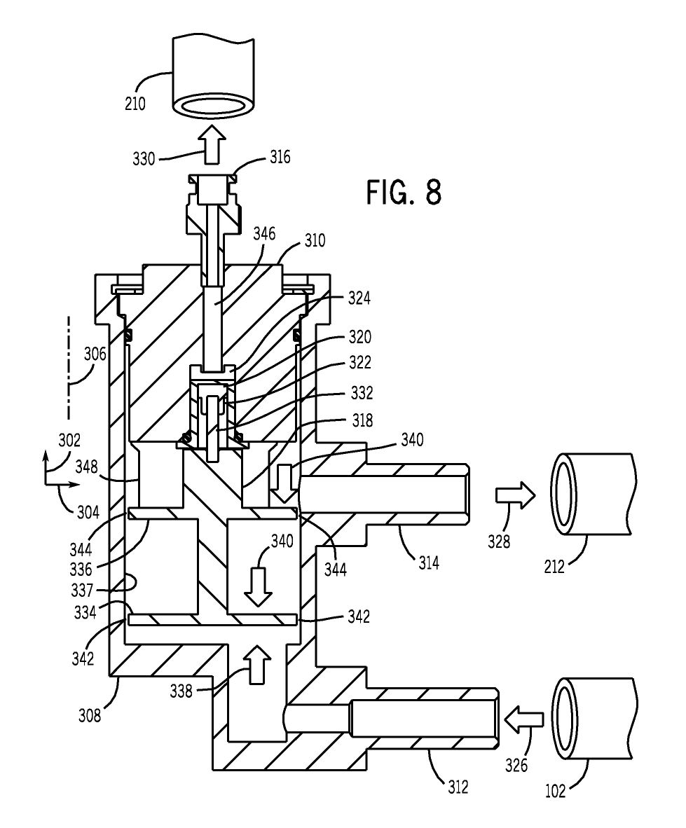

Referring now to FIG. 4, a schematic of an embodiment of the power module 100 of FIG. 3 is shown. The power module 100 includes the mounting portion 110, a housing 200, an air flow switch 202, a turbine generator 204, and a regulator 206. The housing 200 may be rigid or flexible and any size suitable for use with the mounting portion 110. Further, the housing 200 may be configured to provide protection for internal components (e.g., the turbine generator 204) from contamination from sprayed paints or solvents. The turbine generator 204 may be a Pelton-type generator or some other suitable fluid driven generator. Further, the power module 100 may also include a turbine gas regulator 208 to control air flow to the turbine generator 204. In certain embodiments, the gas intake 102 may be sufficient to supply adequate air pressures to both the turbine generator 204 and the gas output 26. Accordingly, the gas intake 102 may be under a pressure of at least 35, 40, 45, 50, 55, 60, 65, or greater psig. As described in detail below with reference to FIGS. 7 and 8, the illustrated embodiment of the air flow switch 202 of FIG. 4 receives the gas intake 102 and directs a portion of the gas intake 102 to a turbine gas intake 210 and another portion of the gas intake 102 to an air flow output 212.

As further illustrated in FIG. 4, certain embodiments of power module 100 may contain the turbine gas regulator 208. The turbine gas regulator 208 may restrict the air flow in a regulated turbine gas intake 214 to a preset pressure suitable for use with the turbine generator 204 for obtaining the desired level of power in the power supply voltage 30. In some embodiments, the turbine gas regulator 208 may be eliminated by instead relying on the turbine generator 204 to limit voltage output by some internal limiting capability (e.g., power limiting circuitry). For example, the turbine generator 204 may internally limit its output voltage to the desired level for the power supply voltage 30. Therefore, the turbine generator 204 may receive an unregulated air flow directly from the turbine gas intake 210 while supplying a constant desired voltage. In either of the above embodiments, the power supply voltage 30 is limited to a desired level desired to provide sufficient power to the cascade voltage multiplier 32 of FIGS. 1 and 2. Further, in some embodiments, power regulation may be performed external to the turbine generator, such as external power limiting circuitry or some other suitable regulating method. Accordingly, the power supply voltage 30 may be limited to a desired voltage, such as approximately 5, 10, 15, 20, 25, or greater volts. Additionally, the power module 100 supplies the power supply voltage 30 via the electrical adapter 108.

Air flow output 212 of FIG. 4 exits the air flow switch 202 to be received by the regulator 206, which is configured to regulate air flow to the gas output 26. In the illustrated embodiment, the regulator 206 is positioned outside the housing 200. Some embodiments are configured to position the regulator 206 within the housing 200, as a portion of the housing 200, or, alternatively, within the spray device 50 of FIG. 2. The regulator 206 may restrict the air pressure provided to the gas output 26 to a range suitable for spraying the electrostatically charged spray 14 of FIGS. 1-3. The regulator 206 may be a preset or adjustable air regulator configured to allow the user to select the pressure of the gas output 26 suitable to a particular application. The variables affecting the suitability of certain pressure in the gas output 26 may include the distance of the spray device 50 of FIG. 2 from the object 16 of FIG. 1, user preference, and/or the properties of the desired coating material. When air flow exits the housing 200 (e.g., the air flow output 212 or the gas output 26), it may do so via the gas adapter 106. As discussed further below in reference to FIG. 5, certain embodiments of the electrostatic spray system 10 may include a grounding circuit that has been omitted from FIG. 3 for clarity.

Referring now to FIG. 5, a circuit diagram of an embodiment of the electrostatic spray tool 10 of FIG. 1, illustrating an embodiment of routing of electrical power and ground lines is provided. In the illustrated embodiment, a grounding circuit 230 includes an earth ground 232, the turbine generator 204, the air flow switch 202, the electrostatic spray device 50, optionally including the magnetic reed switch 80, and an electrical connection 234 to the electrostatic spray device 50. The earth ground 232 includes a ground line 236 to provide a ground connection to the turbine generator 204. Likewise, the earth ground 232 includes a ground line 238 to the electrostatic spray device 50. Further, the turbine generator 204 terminates a positive line 240 and negative line 242 at its respective terminals. In certain embodiments, the air flow switch 202 may placed in series with the negative line 242 or any other suitable location. The four lines (e.g., the ground lines 236 and 238, the positive line 240, and the negative line 242) create a circuit to deliver power and ground to the electrostatic spray device 50 through the electrical connection 234. In some embodiments, the electrical connection 234 may deliver lines in at least one bundle or may deliver lines separately. For example, the electrical connection 234 may combine the connection 78 and the power supply voltage 30 (each from FIG. 2) into one single bundle or may deliver them each separately.

Referring now to FIG. 6, a diagram of an embodiment of the electrostatic spray tool 10 of FIG. 1 illustrating one possible placement for the power module 100 of FIG. 3. In the current embodiment, the power module 100 is portably and removably coupled to a user 300 by the mounting portion 110. In the current embodiment, the mounting portion 110 is illustrated as a belt. Certain embodiments may mount the power module 100 on the user 300 using other portable methods such as backpacks, pouches, or other suitable methods for portable mounting. Certain embodiments may instead mount the power module 100 to another location separate from the user 300 whether portably mounted (e.g., on a cart or on rails) or mounted in a fixed location (e.g., to a wall). The electrostatic spray tool 10 further includes the electrostatic spray device 50 with the trigger assembly 66 discharging the electrostatically charged spray 14.

As further illustrated in FIG. 6, the electrostatic spray tool 10 further illustrates the routing of the gas intake 102 through the gas adapter 104 from the gas supply 20 (not pictured) to the power module 100. Similarly, the gas output 26 is routed from the power module 100 to the electrostatic spray device 50 through the gas adapters 106 and 60. Likewise, the power supply voltage 30 is routed from the power module 100 to the electrostatic spray device 50 through the electrical adapters 108 and 52.

FIG. 7 is a cross-sectional view of an embodiment of the air flow switch 202 of FIG. 4, illustrating a closed position of the air flow switch 202. For purposes of discussion, reference may be made to an axial direction 302 and radial direction 304 relative to a longitudinal axis 306 of the air flow switch 202. Further, the illustrated embodiment of the air flow switch 202 includes a body 308 and an upper housing 310. The air flow switch 202 may receive an air flow through the air intake 102. The air intake 102 is connected to the air flow switch 202 with a gas adapter 312. Similarly, the gas adapter 314 connects the air flow output 212 to the air flow switch 202. Likewise, the gas adapter 316 connects the turbine gas intake 210 to the air flow switch 202. Each of the gas adapters 312, 314, and 316 may be a molded fitting, combination of a quick connector and coupler, or any other method suitable for connecting each respective air passage to the air flow switch 202. Furthermore, certain embodiments may include identical connector methods for the gas adapters 312, 314, and 316 or may include some combination of suitable connecting methods.

As further illustrated in FIG. 7, the air flow switch 202 further includes a piston 318, a poppet 320, a seat 322, and a spring 324. The spring 324 is configured to bias the piston 318 against the body 308 to block air flow through air flow paths 328 and 330 (e.g., air passages). The spring 324 may also be configured to bias the poppet 320 against the seat 322, thereby blocking air flow through air flow path 330. The seat 322 may be made of any material suitable for blocking the air flow path 330 which may include various types of rubber, plastics or other materials suitable for blocking air flow when seating the poppet 320. Additionally, in the illustrated embodiments, the spring 324 biases both the piston 318 and the poppet 320 because a stem 332 couples the piston 318 to the poppet 320 so that movement of the piston 318 in an axial direction 304 also moves the poppet 320. As further illustrated in FIG. 7, the piston 318 and the poppet 320 are shown in a closed position. Additionally, the piston 314 includes a first face 334 and a second face 336. The air flow switch 202 may include some forward pressure 338 and some reverse pressure 340 against the first face 334 and the second face 336. Both pressures may include gravity, vacuums, air pressure, drag, atmospheric pressure, force exerted by the spring 324, or some combination thereof. Additionally, the first face 334 and the second face 336 have a smaller diameter than the interior wall 337 of the housing 308 so that the air flow switch 202 may allow air to flow around both the first face 332 and the second face 334 through air flow gaps 342 and 344. Additionally, the air flow switch 202 has an air flow gap 346. The size of the volumes of air flow gaps 342, 344, and 346 may be chosen to direct a desired proportion of air flow and pressure from the air flow path 326 into the air flow path 330. For example, the air flow path 326 may be configured to accept an input pressure and divert any desired percentage of air flow to the air flow path 330, thereby sending excess flow to the air flow path 328. Lastly, as discussed below in reference to FIG. 8, the air flow switch 202 may further contain a stopper 348 to control the position of the piston 318 when the air flow switch 202 is in the open position.

The illustrated embodiment blocks air flow through the air flow paths 328 and 330 by blocking air flow through the air flow path 326 by biasing the lower edge of the first face 334 against the horizontal portion of the housing 308. As discussed below, the air flow switch 202 blocks air flow through the air flow paths 328 and 330 unless the forward pressure 336 exceeds a certain threshold sufficient to overcome the reverse pressure 340. For example, if the air intake 102 and the air flow output 212 have approximately the same internal pressures without a current air flow, the spring 324 provides additional force to bias the piston 318 against the body 308. Specifically, in the above example, the forward pressure 338 would at least include the pressure in the air intake 102, and the reverse pressure 340 would at least include pressure in the air flow output 212 and the force exerted by the spring 324. Therefore, the forward pressure 338 would not exceed the threshold necessary to overcome the reverse pressure 340. In other words, when the air pressures in the air output 212 and the air intake 102 are approximately the same without any current air flow, the piston 318 blocks air flow through the air flow paths 328 and 330.

FIG. 8 is a cross-sectional view of an embodiment of the air flow switch 202 of FIG. 4, illustrating an open position of the air flow switch 202. For purposes of discussion, reference may be made to an axial direction 302 and a radial direction 304 relative to a longitudinal axis 306 of the air flow switch 202. Further, the illustrated embodiment of the air flow switch 202 includes the body 308 and the upper housing 310. The air flow switch 202 receives air flow through the air intake 102. The air intake 102 is coupled to the air flow switch 202 by the gas adapter 312. Similarly, the gas adapter 314 couples the air flow output 212 to the air flow switch 202, and the gas adapter 316 couples the turbine gas intake 210 to the air flow switch 202. Each of the gas adapters 312, 314, and 316 may be a molded fitting, combination of a quick connector and coupler, or any other method suitable for connecting the air passages to the air flow switch 202. Furthermore, certain embodiments may include identical connector methods for the gas adapters 312, 314, and 316 or may include some combination of suitable connecting methods.

As further illustrated in FIG. 8, the air flow switch 202 is in an open position, illustrating the corresponding open positions for the piston 318, the poppet 320, and the spring 324. The illustrated embodiment of the air flow switch 202 is shown in an open position with the piston 318 abutting the stopper 348. As the forward pressure 338 (e.g., drag created by air flow) exceeds a threshold sufficient to overcome the reverse pressure 340, the piston 318 is driven in an axial direction 304. For example, in certain embodiments, the gas supply 20 may be configured to continuously provide a constant air supply maintaining constant forward pressure 338. When the trigger assembly 66 of FIG. 2 is not actuated, air pressure will build similarly in the air flow paths 328 and 326. As discussed above in reference to FIG. 7, equal air pressures in the air flow paths 326 and 328 may cause the piston 318 to block air flow through the air flow switch 202. However, the forward pressure 338 may exceed the threshold necessary to open the air flow switch 202 when the trigger assembly 66 is actuated. Specifically, actuating the trigger assembly 66 may allow air to flow through the electrostatic spray device 50 and create an evacuation of air from the gas output 26 and the air flow output 212. The evacuation of air from air flow output creates a corresponding drop in air pressure in the air flow passage 328. The drop in pressure in the air flow passage 328 causes a decrease in the reverse pressure 340. In the above embodiment, the reverse pressure 340 would decrease while the forward pressure 338 would remain constant. Therefore, the forward pressure 338 may exceed the threshold required to open the air flow switch 202 by being greater than the reverse pressure 340. As air flow reenters the air flow path 328 through the air flow switch 202, the pressure rebuilds in the air flow path 328. Although the pressure in the air flow path 328 may rebuild, the forward pressure 340 may still exceed the threshold required to open the air flow switch 202 due to the additional force exerted in the form of drag occurring when air flows across the first face 334 and the second face 336. However, once the trigger assembly 66 is no longer actuated, air flow is suspended and the air flow switch 202 may return to the closed position.

Returning to FIG. 8, as the piston 318 moves in axial direction 304, the first face 334 is no longer abutting the horizontal portion of the housing 308 allowing air flow around the first face 334. As air flows around the first face 334 and the second face 336, the air flow creates drag across each face. The drag created by the flow may force the piston 318 further in axial direction 304 until the piston 318 abuts the stopper 348, as illustrated in FIG. 8. As the piston 318 enters into the open position, the piston 318 forces the poppet 320 into a corresponding open position. Specifically, in the illustrated embodiment, the piston 318 drives the stem 332 in the same axial direction 304 in which the piston 318 is driven. The open position of the piston 318, as illustrated in FIG. 8, allows air flow through the air flow path 328. Likewise, the open position of the poppet 320, as illustrated in FIG. 8, allows air flow through the air flow path 330. In other words, the poppet 320 diverts some of the pressure and flow to the air flow path 330. For example, the pressure of air flowing into the air flow path 326 may be within some range of 80 to 100 psig, 50 to 120 psig, and all suitable sub-ranges therein. The air pressures in the air flow paths 328 and 330 may be any portion of the pressure in the air flow path 326. For example, in certain embodiments, the air flow switch 202 may divert a portion (e.g., 30 psig) of the pressure (e.g., 100 psig) within the air flow path 326 to the air flow path 330 with the excess portion being directed into the air flow path 328.

Various embodiments of the present disclosure include an electrostatic tool for providing an electrostatically charged spray to coat a target object. As discussed in detail above, the electrostatic spray tool includes a power module that includes an air flow switch to divert air flow to drive a generator. The electrostatic spray tool uses the power produced by the generator to create an electrostatically charged spray and supply a gas output to a spray device for atomizing the electrostatically charged spray. As discussed above, the placement and configuration of the power module may reduce the number of cables used with the electrostatic tool while improving the ergonomics of an electrostatic spray system, thereby protecting the power supplies and improving user efficiency, while using cost effective parts. Various embodiments of the present disclosure provide a power module having an air flow switch that detects a change in air flow so as to reduce the need for extra cables, hoses, and/or additional weight in the spray device. As discussed above, removably coupling the power module on the user may make the spray device lighter, more comfortable to use, and more durable.

1. A system, comprising:
a power module for an electrostatic tool, comprising:
an air flow switch, comprising:
a first air flow passage configured to receive a first air flow;
a second air flow passage configured to output a first portion of the first air flow; and
a third air flow passage configured to output a second portion of the first air flow,
wherein the air flow switch is configured to flow the first portion of the first air flow through the second air flow passage and flow the second portion of the first air flow through the third air flow passage when the first air flow exceeds a threshold pressure.

2. The system of claim 1, wherein the air flow switch comprises a piston configured to block the first portion of the first air flow from flowing through the second air flow passage and block the second portion of the first air flow from flowing through the third air flow passage when the first air flow is below the threshold pressure.

3. The system of claim 2, wherein the piston is configured to allow the first portion of the first air flow through the second air flow passage and enable flow of the second portion of the first air flow through the third air flow passage when the first air flow exceeds the threshold pressure.

4. The system of claim 1, wherein the second air flow passage is configured to direct the first portion of the first air flow to a turbine generator.

5. The system of claim 4, wherein the power module comprises the turbine generator, and the turbine generator is configured to generate a voltage from the first portion of the first air flow.

6. The system of claim 1, wherein the third air flow passage is configured to direct the second portion of the first air flow to a spray device of the electrostatic tool.

7. The system of claim 1, wherein the air flow switch comprises a piston biased in a closed position when the first air flow is below the threshold pressure.

8. The system of claim 7, wherein the piston blocks the first portion of the first air flow from flowing through the second air flow passage and blocks the second portion of the first air flow from flowing through the third air flow passage when the piston is in the closed position.

9. The system of claim 7, wherein the air flow switch comprises a spring that biases the piston in the closed position when the first air flow is below the threshold pressure.

10. The system of claim 1, wherein the air flow switch is configured to receive the first air flow from an air supply external to the portable power module.

11. The system of claim 1, wherein the electrostatic tool comprises a spray coating device configured to output an electrostatically charged spray.

12. A system, comprising:
a portable power module for an electrostatic spray device, comprising:
an air flow switch comprising a piston;
wherein the air flow switch is configured to receive a first air flow, output a second air flow, and output a third air flow, wherein piston is configured to block the second air flow and the third air flow when the first air flow is below a threshold pressure.

13. The system of claim 12 further comprising a spring, wherein the spring biases the piston to block the second air flow and the third air flow when the first air flow is below the threshold pressure.

14. The system of claim 12, wherein the air flow switch is configured to direct a first portion of the first air flow into a second air flow and direct a second portion of the first air flow into the third air flow.

15. The system of claim 14, wherein the air flow switch comprises a poppet coupled to the piston, wherein the poppet is configured to direct the second portion of the first air flow into the third air flow.

16. The system of claim 12, wherein the air flow switch is configured to flow the second air flow to a turbine generator.

17. The system of claim 12, wherein the air flow switch is configured to flow the third air flow to the electrostatic spray device.

18. A system, comprising:
an spray coating device configured to output an electrostatically charged spray; and
a power module separate from the spray coating device, comprising:
an air flow switch, comprising:
a first air flow passage configured to receive a first air flow;
a second air flow passage configured to direct a first portion of the first air flow to a turbine generator of the power module; and
a third air flow passage configured to direct a second portion of the first air flow to the spray coating device,
wherein the air flow switch is configured to flow the first portion of the first air flow through the second air flow passage and flow the second portion of the first air flow through the third air flow passage when the first air flow is exceeds a threshold pressure.

19. The system of claim 18, further comprising a piston configured to block the first portion of the first air flow from flowing through the second air flow passage and to block the second portion of the first air flow from flowing through the third air flow passage when the first air flow does not exceed the threshold pressure.

20. The system of claim 19 further comprising a spring configured to bias the piston to block the first portion of the first air flow from flowing through the second air flow passage and to block the second portion of the first air flow from flowing through the third air flow passage when the first air flow does not the threshold pressure.
